(19) United States
(12) Patent Application Publication
(10) Pub. No.: US 2021/0238353 A1
(43) Pub. Date: Aug. 5, 2021

(54) METHOD OF PRODUCING POLYARYLENE SULFIDE

(71) Applicant: Kureha Corporation, Tokyo (JP)

(72) Inventor: Kenji SUZUKI, Tokyo (JP)

(21) Appl. No.: 17/262,863

(22) PCT Filed: Jun. 6, 2019
(86) PCT No.: PCT/JP2019/022565

§ 371 Date: Jan. 25, 2021

(30) Foreign Application Priority Data
Jul. 31, 2018 (JP) 2018-143467

(51) Int. Cl. C08G 75/0259; C08G 75/0254; C08G 75/0213; C08K 5/3415; B01J 19/24; B01J 4/00

(52) U.S. Cl. CPC C08G 75/0259; C08G 75/0254; C08G 75/0213; B01J 2219/24; B01J 19/245; B01J 4/008; B01J 2219/00033; C08K 5/3415

(57) ABSTRACT

A method of producing a polyarylene sulfide (PAS) with a high nitrogen content in the PAS, the method thereof improving the characteristics of the PAS while reducing the amount of organic by-products, and using a plurality of reaction vessels that are in communication with each other through a gas phase. In the production method, a supply step, a water removal step, a polymerizing step, and a recovering step are performed in parallel. A polar organic solvent, a sulfur source, and a dihalo aromatic compound are used as reaction raw materials. A supply amount of the polar organic solvent used as a reaction raw material is 5 mol or less per mole of the sulfur source used as a reaction raw material. The polar organic solvent has a bond represented by —RO—N—, where R is C or P.

### TECHNICAL FIELD

The present invention relates to a method of producing a polyarylene sulfide.

### BACKGROUND ART

It is known that organic by-products may be produced in the production of polyarylene sulfides. For example, Patent Document 1 discloses a method for producing a polyarylene sulfide (hereinafter, also abbreviated as “PAS”) by polymerizing a sulfur source and a dihalo aromatic compound in the presence of an alkali metal hydroxide in a polar organic solvent, and indicates that chlorophenyl methylamino butanoic acid (hereinafter, also abbreviated as “CPMABA”) or the like is generated as an organic by-product.

Patent Document 1 also discloses a method for producing PAS having a reduced amount of CPMABA. That is, Patent Document 1 indicates that the produced amount of the CPMABA is reduced by using an alkali metal hydroxide of an amount less than an equimolar amount relative to the sulfur source at the time of charging, and adding the remaining alkali metal hydroxide in the polymerizing step

Patent Document 2 discloses an efficient method for producing PAS. Patent Document 2 discloses a PAS continuous production method that enables a conservation of resources, energy savings, and a reduction in equipment costs. Specifically, Patent Document 2 discloses a PAS continuous production method in which a housing chamber accommodating a plurality of reaction vessels is provided, at least an organic amide solvent, a sulfur source, and a dihalo aromatic compound are supplied to the housing chamber, a polymerization reaction between the sulfur source and the dihalo aromatic compound is carried out in the organic amide solvent in the reaction vessels, and thereby a reaction mixture is formed, the reaction vessels are communicated with each other through a gas phase in the housing chamber, the reaction vessels are sequentially connected, and the reaction mixture sequentially transfers to each reaction vessel.

### CITATION LIST

### Patent Document

Patent Document 1: WO 2015/152032

Patent Document 2: WO 2017/179327

### SUMMARY OF INVENTION

### Technical Problem

Organic by-products such as halogenated aromatic aminoalkyl acids are produced by consuming a dihalo aromatic compound such as para-dichlorobenzene (hereinafter, also abbreviated as “pDCB”), which is a raw material of PAS, a polar organic solvent such as N-methyl-2-pyrrolidone (hereinafter, also abbreviated as “NMP”), and sodium hydroxide. The generation of the halogenated aromatic aminoalkyl acid stops the polymerization reaction, and results in the occurrence of problems when molding (such as the generation of volatile content and “sticky deposit” or the like). Therefore, a demand has arisen for the development of an efficient production method that reduces the amount of organic by-products generated.

However, while Patent Document 1 discloses a reduction in the amount of organic by-products generated, Patent Document 1 does not indicate that the characteristics of the PAS are also improved.

Furthermore, Patent Documents 1 and 2 do not describe efficient methods for producing PAS with a high nitrogen content and improved PAS characteristics while reducing the amount of organic by-products.

Therefore, an object of the present invention is to provide an efficient method for producing PAS with a high nitrogen content in the PAS, the method thereof improving the PAS characteristics while reducing the amount of organic by-products generated.

### Solution to Problem

As a result of diligent research to solve the problems described above, the inventors of the present invention discovered that a PAS with a high nitrogen content and improved PAS characteristics can be produced while reducing the amount of organic by-products by setting the supply amount of a specific polar organic solvent, which is a reaction raw material, to within a specific range, and on the basis of that discovery, the present inventors arrived at the present invention.

The present invention is a method of producing a polyarylene sulfide, the method including:

a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring a reaction mixture obtained through the polymerizing step among the reaction vessels; and
a recovering step of recovering the reaction mixture; wherein a supply amount of the polar organic solvent is 5 mol or less per 1 mol of the sulfur source;
the reaction vessels are within a continuous production apparatus provided with a housing chamber accommodating the plurality of reaction vessels connected in series;
the reaction vessels are communicated with each other through a gas phase in the housing chamber;
the supply step, the water removal step, the polymerizing step, and the recovering step are performed in parallel; and
the polar organic solvent has a bond represented by —RO—N—, where R is C or P.

In addition, the present invention is a method of producing a polyarylene sulfide, the method including:

a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring a reaction mixture obtained through the polymerizing step among the reaction vessels; and
a recovering step of recovering the reaction mixture; wherein
a supply amount of the polar organic solvent is 5 mol or less per 1 mol of the sulfur source;
the plurality of reaction vessels is connected through a ventilation unit so as to communicate with each other through the gas phase;
the reaction vessels adjacent each other are connected by piping;
the supply step, the water removal step, the polymerizing step, and the recovering step are performed in parallel; and the polar organic solvent has a bond represented by —RO—N—, where R is C or P.

### Advantageous Effects of Invention

With the method of producing a polyarylene sulfide according to the present invention, PAS having a high nitrogen content in the PAS can be produced with improved PAS characteristics while reducing the amount of organic by-products.

### DESCRIPTION OF EMBODIMENTS

An embodiment of the method of producing polyarylene sulfide (PAS) according to the present invention is described hereinafter.

The method of producing a polyarylene sulfide (PAS) according to the present embodiment includes:

a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring a reaction mixture obtained through the polymerizing step among the reaction vessels; and
a recovering step of recovering the reaction mixture; wherein a supply amount of the polar organic solvent is 5 mol or less per 1 mol of the sulfur source;
the reaction vessels are within a continuous production apparatus provided with a housing chamber accommodating the plurality of reaction vessels connected in series;
the reaction vessels are communicated with each other through a gas phase in the housing chamber;
the supply step, the water removal step, the polymerizing step, and the recovering step are performed in parallel; and
the polar organic solvent has a bond represented by —RO—N—, where R is C or P.

The PAS obtained by the method of producing a PAS according to the present embodiment is a linear or branched PAS, and is preferably polyphenylene sulfide (PPS).

The weight average molecular weight (Mw) of the PAS obtained by the method of producing PAS according to the present embodiment covers a wide range. Typically, a lower limit of the weight average molecular weight of PAS obtained through gel permeation chromatography (GPC) calibrated with polystyrene standards is at least 2000, preferably at least 10000, and more preferably at least 15000. Furthermore, the upper limit of this weight average molecular weight is not greater than 300000, and preferably not greater than 100000.

In the method of producing a PAS according to the present embodiment, a PAS continuous production apparatus provided with a housing chamber accommodating a plurality of reaction vessels can be used. Examples of the PAS continuous production apparatus include those disclosed in Patent Document 2, WO 2019/074051, and WO 2019/074052.

Furthermore, in the PAS continuous production apparatus according to the present embodiment, the plurality of reaction vessels is connected through a ventilation unit, and thus are communicated with each other through a gas phase, and adjacent reaction vessels may be connected through piping. Said PAS continuous production apparatus is disclosed in WO 2018/159220, for example.

In the supply step, the polar organic solvent, the sulfur source, and the dihalo aromatic compound are supplied as reaction raw materials to at least one of the plurality of reaction vessels that are communicated with each other through the gas phase. Each reaction vessel may be separated by a fixed or movable partition wall.

In the method of producing PAS according to the present embodiment, a polar organic solvent, a sulfur source, and a dihalo aromatic compound are used as reaction raw materials.

The reaction raw materials may each be supplied through a different supply line, or some or all of the reaction raw materials may be premixed and then supplied to the reaction vessels. For example, a mixture of a polar organic solvent and a dihalo aromatic compound may be prepared in advance, and then the mixture may be supplied to the reaction vessels. Furthermore, a mixture of the polar organic solvent and the sulfur source may be prepared in advance, and the mixture may then be supplied to the reaction vessels. For example, NMP and sodium sulfide or sodium hydrosulfide may be reacted to form a complex (SMAB-NaSH) containing sodium aminobutyrate (SMAB) and/or sodium hydrosulfide (NaSH), and then supplied. When the mixture contains water, the mixture may be used after removing at least a portion of the water.

In the present embodiment, “polar organic solvent” refers to a polar organic solvent having a bond represented by —RO—N—, where R is C or P.

Examples of the organic amide solvent include acyclic N,N-dialkyl amide compounds, such as N,N-dimethylformamide and N,N-dimethylacetamide; caprolactam compounds or N-alkylcaprolactam compounds, such as ε-caprolactam and N-methyl-ε-caprolactam; pyrrolidone compounds, N-alkylpyrrolidone compounds or N-cycloalkylpyrrolidone compounds, such as 2-pyrrolidone, N-methyl-2-pyrrolidone (NMP), N-ethyl-2-pyrrolidone, and N-cyclohexyl-2-pyrrolidone; N,N-dialkylimidazolidinone compounds, such as 1,3-dialkyl-2-imidazolidinone; tetraalkyl urea compounds, such as tetramethyl urea; and hexaalkylphosphate triamide compounds, such as hexamethyl phosphate triamide. From the perspective of easily producing PAS having a high nitrogen content and improved characteristics of the PAS, the polar organic solvent is preferably at least one type of cyclic organic amide solvent selected from a caprolactam compound or an N-alkylcaprolactam compound, a pyrrolidone compound, an N-alkylpyrrolidone compound including an N-cycloalkylpyrrolidone compound, and an N,N-dialkyl imidazolidinone compound, and an N-alkylpyrrolidone compound such as N-methyl-2-pyrrolidone (NMP) is even more preferable.

At least one type of sulfur source selected from the group consisting of hydrogen sulfide, alkali metal sulfides and alkali metal hydrosulfides is used as the sulfur source. If hydrogen sulfide or an alkali metal hydrosulfide is used as the sulfur source, it is preferable to use a suitable amount of an alkali metal hydroxide in combination.

From perspectives such as handling ease, the sulfur source is preferably at least one type selected from the group consisting of alkali metal sulfides and alkali metal hydrosulfides.

Examples of the alkali metal sulfides include lithium sulfide, sodium sulfide, potassium sulfide, rubidium sulfide, and cesium sulfide.

Examples of the alkali metal hydrosulfides include lithium hydrosulfide, sodium hydrosulfide, potassium hydrosulfide, rubidium hydrosulfide, and cesium hydrosulfide.

The sulfur source is preferably handled, for example, in a state of an aqueous slurry or an aqueous solution. From perspectives of handling ease such as measurability and transportability, the sulfur source is preferably handled in an aqueous solution state.

Examples of the dihalo aromatic compound include o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide, and dihalodiphenyl ketone. Of these, p-dihalobenzene is preferable, and p-dichlorobenzene is more preferable.

Furthermore, to produce a branched or crosslinked polymer, a polyhalo compound (not necessarily an aromatic compound) in which three or more halogen atoms are bonded, an active hydrogen-containing halogenated aromatic compound, a halogenated aromatic nitro compound, or the like may be used in combination. Preferable examples of the polyhalo compound as a branching/crosslinking agent include trihalobenzene.

Halogen atoms refer atoms of fluorine, chlorine, bromine, and iodine, and the halogen atoms in the dihalo aromatic compound and the polyhalo compound may be optionally selected from these atoms. For example, the two halogen atoms in the dihalo aromatic compound may be the same or different.

These compounds can be used at an amount from approximately 0.01 to 5 mol % with respect to the dihalo aromatic compound.

In the present embodiment, a polymerization aid having an effect of increasing the molecular weight of the obtained polymer can be used as necessary.

Specific examples of such polymerization aids include organic carboxylates, organic sulfonates, alkali metal sulfates, alkaline earth metal oxides, alkali metal phosphates, and alkaline earth metal phosphates. Of these, organic carboxylates are preferably used. More specific examples of organic carboxylates include lithium acetate, sodium acetate, potassium acetate, lithium propionate, sodium propionate, lithium benzoate, sodium benzoate, sodium phenyl acetate, and sodium p-tolulate. One or more types of organic carboxylates can be used simultaneously. Among these, lithium acetate and/or sodium acetate is preferably used, and sodium acetate is more preferably used because it is inexpensive and easy to obtain.

The organic polar solvent, the sulfur source, the dihalo aromatic compound, the branching/crosslinking agent, and the polymerization aid may each be used alone or may be used as a mixture of two or more types as long as the combination can produce the PAS.

Note that, for example, when the reaction raw materials supplied to the housing chamber are mostly in an anhydrous state, water may be added to at least some of the reaction vessels 1a to 1c in order to promote the reaction.

In the water removal step, at least a portion of the water present in the reaction vessels is removed.

Examples of the water in the reaction vessels include water supplied to the reaction vessels and water produced by a polymerization reaction. Here, “water supplied to the reaction vessels” refers to, for example, water actively supplied to the reaction vessels, and for a case in which water is not actively supplied to the reaction vessels, refers typically to water supplied to the reaction vessels together with the reaction raw materials, in a state of being contained in the reaction raw materials. Because water has a high vapor pressure, when a large amount of moisture is included in the gas phase of the reaction vessels, the pressure of the reaction vessels tends to be high, and thus the reaction vessels must exhibit pressure resistance. As a result, it is difficult to conserve resources and reduce equipment costs. However, resource conservation and a reduction in equipment costs, etc. can be effectively achieved by removing water and reducing the pressure inside the reaction vessels. The pressure inside the reaction vessel can be reduced to from approximately 0.2 to 0.3 MPa, for example, and can be preferably reduced to approximately 0.04 MPa.

In the PAS production apparatus used in the method of producing PAS according to the present embodiment, a water removing unit may be provided as described in Patent Document 2, for example.

In the polymerizing step, a polymerization reaction is performed in the plurality of reaction vessels.

The supplied polar organic solvent, sulfur source, and dihalo aromatic compound are mixed in the reaction vessels, a polymerization reaction between the sulfur source and the dihalo aromatic compound is carried out in the polar organic solvent, and thereby a reaction mixture is formed.

The polymerization reaction is carried out at a temperature from 170 to 290° C. until the conversion rate of the dihalo aromatic compound is 50% or higher, preferably 80%, more preferably 90%, even more preferably 95% or higher, and particularly preferably 96% or higher, and thereby a PAS having a weight average molecular weight of not less than 2000, preferably not less than 10000, and particularly preferably not less than 15000, and also not greater than 300000, and preferably not greater than 100000 can be obtained.

A low molecular weight substance polymerization reaction that produces a low molecular weight polymer from the sulfur source and a dihalo aromatic compound is also one preferable aspect. In the low molecular weight substance polymerization reaction, a mixture made from the polar organic solvent, the sulfur source, and the dihalo aromatic compound is heated to initiate a polymerization reaction, and a relatively low molecular weight polymer with a dihalo aromatic compound conversion rate of 50% or greater is produced.

In the low molecular weight substance polymerization reaction, preferably, the polymerization reaction is initiated by heating at a temperature of from 170 to 270° C., and a relatively low molecular weight polymer having a dihalo aromatic compound conversion rate of 50% or greater is produced. The polymerization temperature in the low molecular weight substance polymerization reaction is preferably selected from the range of 180 to 265° C. from the perspective of suppressing side reactions and/or decomposition reactions.

The conversion rate of the dihalo aromatic compound in the low molecular weight substance polymerization reaction is preferably from 50 to 98%, more preferably from 60 to 97%, even more preferably from 65 to 96%, and particularly preferably from 70 to 95%.

The weight average molecular weight of the low molecular weight substance is not less than 2000, preferably not less than 5000, and more preferably not less than 6000, and also not more than 10000, and preferably not more than 9000.

The conversion rate of the dihalo aromatic compound in the present embodiment can be calculated by determining, through gas chromatography, the amount of the dihalo aromatic compound remaining in the reaction mixture, and then calculating the conversion rate on the basis of the remaining amount of the dihalo aromatic compound, the charged amount of the dihalo aromatic compound, and the charged amount of the sulfur source.

In the transfer step, the reaction mixture obtained by the polymerizing step is sequentially transferred among reaction vessels.

In the recovering step, the reaction mixture is recovered.

In the method of producing PAS according to the present embodiment, the supply step, the water removal step, the polymerizing step, and the recovering step are performed in parallel, and preferably, the supply step, the water removal step, the polymerizing step, the transfer step, and the recovering step are performed in parallel.

From the perspectives of improving productivity and improving the PAS characteristics while suppressing the production of organic by-products, the supply amount of the polar organic solvent is preferably 5 mol or less, more preferably 4 mol or less, and even more preferably 3.5 mol or less, per 1 mol of the sulfur source. Note that the lower limit of the supply amount of the polar organic solvent is not limited, but from the perspective of sufficiently promoting the polymerization reaction, the amount of the polar organic solvent that is supplied is preferably 1 mol or greater per mole of the sulfur source.

In the method of producing PAS according to the present embodiment, preferably, the plurality of reaction vessels is connected in order of a high maximum liquid surface level of liquid that can be accommodated in each reaction vessel, and the reaction mixture is sequentially transferred using the height difference in the maximum liquid surface levels.

For example, a configuration may be adopted in which at least one or more sets of reaction vessels from combinations of adjacent reaction vessels are connected in order of a high maximum liquid surface level of liquid that can be accommodated by the reaction vessel. The configuration may also be such that the reaction mixture is transferred from a reaction vessel with a higher maximum liquid surface level to a reaction vessel with a lower maximum level in accordance with the height difference in the maximum liquid surface levels.

With this configuration, the reaction mixture transfers in accordance with gravity and the difference in the liquid surface levels, and thus it is unnecessary to provide a separate means for transferring the reaction mixture to the next reaction vessel. Gravitational force is used to transfer the reaction mixture on the basis of the height difference and the like of the maximum liquid surface levels, and thus a large amount of energy is not required. Therefore, the configuration can be used to easily achieve resource conservation, energy savings, and a reduction in equipment costs, and the like.

When the height of the reaction mixture exceeds the maximum liquid surface level of the reaction vessel, the reaction mixture flows into a communicating reaction vessel having a lower maximum liquid surface level. In the reaction vessel into which the reaction mixture flows, a polymerization reaction between the sulfur source and the dihalo aromatic compound is carried out in a polar organic solvent, and a reaction mixture is formed. Furthermore, when the height of the reaction mixture exceeds the maximum liquid surface level of the reaction vessel, the reaction mixture flows into a communicating reaction vessel having a lower maximum liquid surface level.

In addition, in the method of producing a PAS according to the present embodiment, when the polar organic solvent is a cyclic organic amide solvent, the value determined by Equation (1) below can be 4 mol/mol or less, or even 3 mol/mol or less, and can also be 2.5 mol/mol or less.

(A)×(B)/(C) (1)

where in Equation (1),
(A) represents a supply amount [mol/mol] of the cyclic organic amide solvent per 1 mol of the sulfur source;
(B) represents a produced amount [mmol/mol] of halogenated aromatic aminoalkyl acid per 1 mol of the sulfur source, the halogenated aromatic aminoalkyl acid being produced as an organic by-product in the polymerizing step; and
(C) represents a nitrogen content [mmol/mol] contained in the polyarylene sulfide per 1 mol of the sulfur source.
When the value determined by Equation (1) is as described above, chlorine at the terminal of the PAS reacts with SMAB, nitrogen is introduced into the PAS chain, and a carboxyl group is also introduced at the PAS terminal. As a result, effects are exhibited such as being able to improve the reactivity of the PAS, being able to improve the mechanical properties of the molded product, and being able to suppress the occurrence of burrs in the molded product by forming a crosslinked structure.

Note that the lower limit of the value determined by Equation (1) above is not limited, but may be 1 mol/mol or greater.

In the method of producing a PAS according to the present embodiment, the production amount (B) of the halogenated aromatic aminoalkyl acid is preferably 4.4 mmol or less, more preferably 4.3 mmol or less, and even more preferably 4.1 mmol or less, per 1 mol of the sulfur source. When the production amount of halogenated aromatic aminoalkyl acid is within the range described above, consumption of the raw materials can be suppressed. Furthermore, the unit consumption can be improved, and the amount of industrial waste can be reduced. In addition, since the halogenated aromatic aminoalkyl acid acts as a polymerization terminator for PAS, the amount of halogenated aromatic aminoalkyl acid that is produced is reduced, and as a result, a high degree of PAS polymerization can be achieved, and the yield of the PAS can be improved.

In the method of producing a PAS according to the present embodiment, the nitrogen content (C) contained in the polyarylene sulfide per 1 mol of the sulfur source is preferably from 2.0 to 7.0 mmol/mol, more preferably from 4.0 to 6.0 mmol/mol, and even more preferably from 4.5 to 5.5 mmol/mol.

A carboxyl group is also introduced into the PAS along with nitrogen in the reaction between PAS and SMAB. The carboxyl group can improve adhesion or affinity between the PAS and glass (glass fibers, glass board) by reacting with an amino group of aminosilane to form an amide bond. Furthermore, the carboxyl group also reacts with an epoxy group of epoxy silane to produce an ester bond, and thereby adhesion or affinity can be improved.

As a result of improving adhesion or affinity, the effects such as being able to improve the mechanical properties of the molded product and being able to suppress the occurrence of burrs in the molded product by forming a crosslinked structure are exhibited.

Meanwhile, if the nitrogen content is too high, the thermal stability of the added SMAB portion is low, and therefore degradation occurs during thermoforming, and the degradation product thereof causes undesirable volatile content and the like. If the nitrogen content is too low, the carboxyl group content of the PAS terminal will be low, and reactivity with an aminosilane or the like is reduced.

In a conventional batch-type PAS production method, when the amount of solvent is reduced in order to increase productivity, the amount of organic by-products increases. However, according to the production method of the present embodiment, the generation of organic by-products can be dramatically suppressed to a low value even when the amount of the solvent is reduced. Furthermore, as also demonstrated in the examples described below, the value determined by Equation (1) above tends to be lower when the amount of solvent is reduced, even in batch-type production. However, according to the production method of the present embodiment, by setting the solvent amount to a predetermined range, the value determined by Equation (1) can be suppressed to a significantly lower value.

### SUMMARY

The method of producing a polyarylene sulfide according to the present embodiment includes:

a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring the reaction mixture among the reaction vessels; and
a recovering step of recovering the reaction mixture obtained through the polymerizing step; wherein
a supply amount of the polar organic solvent is 5 mol or less per 1 mol of the sulfur source;
the reaction vessels are within a continuous production apparatus provided with a housing chamber accommodating the plurality of reaction vessels connected in series;
the reaction vessels are communicated with each other through a gas phase in the housing chamber;
the supply step, the water removal step, the polymerizing step, and the recovering step are performed in parallel; and
the polar organic solvent has a bond represented by —RO—N—, where R is C or P.

In addition, the method of producing a polyarylene sulfide according to the present embodiment includes:

a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring the reaction mixture obtained through the polymerizing step, among the reaction vessels; and
a recovering step of recovering the reaction mixture; wherein
a supply amount of the polar organic solvent is 5 mol or less per 1 mol of the sulfur source;
the plurality of reaction vessels are connected through a ventilation unit so as to communicate with each other through a gas phase;
the reaction vessels adjacent to each other are connected by piping;
the supply step, the water removal step, the polymerizing step, and the recovering step are performed in parallel; and
the polar organic solvent has a bond represented by —RO—N—, where R is C or P.

In the method of producing a polyarylene sulfide according to the present embodiment, preferably, the plurality of reaction vessels are connected in order of a high maximum liquid surface level of liquid that can be accommodated in each reaction vessel, and the reaction mixture is sequentially transferred using the height difference in the maximum liquid surface levels.

In the method of producing a polyarylene sulfide according to the present embodiment, the supply step, the water removal step, the polymerizing step, the transfer step, and the recovering step are preferably performed in parallel.

Furthermore, in the method of producing polyarylene sulfide according to the present embodiment, preferably, the polar organic solvent is a cyclic organic amide solvent, and the value determined by Equation (1) below is 4 mol/mol or less.

(A)×(B)/(C) (1)

where in Equation (1),
(A) represents a supply amount [mol/mol] of the cyclic organic amide solvent per 1 mol of the sulfur source;
(B) represents a produced amount [mmol/mol] of halogenated aromatic aminoalkyl acid per 1 mol of the sulfur source, the halogenated aromatic aminoalkyl acid being produced as an organic by-product in the polymerizing step; and
(C) represents a nitrogen content [mmol/mol] contained in the polyarylene sulfide per 1 mol of the sulfur source.]

Furthermore, in the method of producing a polyarylene sulfide according to the present embodiment, preferably, the polar organic solvent is N-alkyl-2-pyrrolidone, and the dihalo aromatic compound is p-dichlorobenzene.

Furthermore, in the method of producing a polyarylene sulfide according to the present embodiment, preferably, a produced amount of the halogenated aromatic aminoalkyl acid is not greater than 4.3 mmol per 1 mol of the sulfur source.

Embodiments of the present invention will be described in further detail hereinafter using examples. The present invention is not limited to the examples below, and it goes without saying that various aspects are possible with regard to the details thereof. Furthermore, the present invention is not limited to the embodiments described above, and various modifications are possible within the scope indicated in the claims. Embodiments obtained by appropriately combining the technical means disclosed by the embodiments are also included in the technical scope of the present invention. In addition, all of the documents described in the present specification are herein incorporated by reference.

### EXAMPLES

### Example 1: Production of PAS

As the PAS production apparatus, the PAS continuous production apparatus illustrated in FIG. 1 of Patent Document 2 was used. Specifically, the PAS production apparatus was a horizontal-type continuous polymerization apparatus made of titanium with dimensions including a diameter of 100 mm and a length of 300 mm, and having a semi-circular partitioning wall.

The PAS continuous production apparatus was charged with 950 g of NMP, after which a temperature 1 of a portion demarcated by a second partition wall and a third partition wall from the upstream side was maintained at 250° C., and a temperature 2 of a portion demarcated by the third partition wall and a fourth partition wall was maintained at 260° C., and a constant-flow pump was used to continuously supply raw materials from each supply line including an NMP-pDCB liquid mixture (NMP:pDCB (mass ratio)=1090.2:767.4) supplied at a flow rate of 2.16 g/min, and 36.40 mass % NaSH supplied at a flow rate of 0.91 g/min. Simultaneously, water was continuously removed from the PAS continuous production apparatus using a distillation device connected to the PAS continuous production apparatus while controlling the pressure to a gauge pressure of 0.3 MPa with a pressure adjustment valve, and the pDCB accompanied with the water that was removed was separated with a settler, and the entire amount thereof was returned to the reaction vessel at the upstream side of the first partition wall from the upstream side. The gas from the distillation device was washed with 14.52 mass % NaOH at a rate of 1.62 g/min and with NMP at a rate of 0.50 g/min, and released, the NaOH and NMP being supplied to a gas absorption column. At this time, the total amount of the NMP and NaOH aqueous solution, which had absorbed gas, was supplied to the reaction vessel of the upstream side of the first partition wall from the upstream side.

In the present example, a supply amount (A) of NMP per 1 mol of the sulfur source (NMP/S) was 3.0 mol/mol, a supply amount of pDCB per 1 mol of the sulfur source (pDCB/S) was 1.03 mol/mol, and a supply amount of NaOH per 1 mol of the sulfur source (NaOH/S) was 1.00 mol/mol.

Furthermore, during PAS production, the nitrogen flow rate was 0.1 L/min (constantly circulated during polymerization), the average residence time was 4 hours, and the polymer slurry collection time was 1 hour during a period of 8 to 9 hours. The collected polymer slurry was recovered through centrifugation, and the separated and recovered polymer was washed three times with acetone and then washed three times with water. The obtained cake was dried under vacuum at 80° C. for 8 hours, and a PPS powder was obtained. The weight average molecular weight Mw of the PAS powder determined through GPC was 21600.

### Example 2: Production of PAS

PAS was produced in the same manner as in Example 1 with the exception that the supply amount (A) (NMP/S) of NMP per 1 mol of the sulfur source was set to 2.5 mol/mol. The weight average molecular weight Mw of the PAS powder determined through GPC was 18900.

### Comparative Example 1: Production of PAS

PAS was produced in the same manner as in Example 1 with the exception that the supply amount (A) (NMP/S) of NMP per 1 mol of the sulfur source was set to 6.1 mol/mol. The weight average molecular weight Mw of the PAS powder determined through GPC was 21300.

### Comparative Example 2: Production of PAS Through Batch-Type Polymerization

A 1 L titanium autoclave equipped with a stirrer was filled with 504.51 g of NMP, 45.50 g of a 62.16 mass % sodium hydrosulfide solution, and 25.07 g of a 73.27 mass % sodium hydroxide aqueous solution. The supply amount (A) (NMP/S) of NMP per 1 mol of the sulfur source was 10.1 mol/mol.

The autoclave was further charged with 78.61 g of pDCB and sealed, after which the inside of the autoclave was replaced with nitrogen, and the mixture was heated to 220° C. while stirring. Next, the temperature was increased to 260° C. over 120 minutes, and a polymerization reaction was performed. Subsequently, 27.27 g of water and 1.9 g of 97 mass % sodium hydroxide were mixed, after which the mixture was pumped into the autoclave by a pump, and then the contents inside the autoclave were heated to a temperature of 265° C. and subjected to a polymerization reaction for 2.5 hours while being maintained at that temperature.

After completion of the reaction, the reaction mixture was cooled to around room temperature, and the reaction solution was passed through a 100-mesh screen. Thus, a granular polymer was separated by sieving. The separated polymer was washed twice with acetone and then washed three times with water. Next, the polymer was washed with 0.3 mass % of an aqueous acetic acid solution, and then washed four times with water. Next, the washed polymer was dried at 105° C. for 13 hours, and a granular PAS was obtained. The weight average molecular weight Mw of the granular PAS determined through GPC was 37100.

### Comparative Example 3: Production of PAS Through Batch-Type Polymerization

PAS was produced in the same manner as in Comparative Example 2 with the exception that the supply amount (A) (NMP/S) of NMP per 1 mol of the sulfur source was set to 3.8 mol/mol. The weight average molecular weight Mw of the granular PAS determined through GPC was 31000.

### Comparative Example 4: Production of PAS Through Batch-Type Polymerization

PAS was produced in the same manner as in Comparative Example 2 with the exception that the supply amount (A) (NMP/S) of NMP per 1 mol of the sulfur source was set to 3.0 mol/mol. The weight average molecular weight Mw of the granular PAS determined through GPC was 31500.

The polymerization compositions of each of Comparative Examples 2 to 4 are shown in Table 1. In Comparative Examples 3 and 4, water was removed by distillation prior to the polymerization reaction because the desired H₂O/S (amount of H₂O per 1 mol of the sulfur source) was not achieved due to the moisture contained in the raw materials.

TABLE 1

| | | | Compar- | Compar- | Compar- |
|---|---|---|---|---|---|
| | | | ative | ative | ative |
| | | | Example | Example | Example |
| Batch No. | | | 2 | 3 | 4 |
| 1st | NMP/S | (g/mol) | 10.1 | 3.8 | 3.0 |
| polymer- | NaOH/S | (mol/mol) | 1.00 | 1.00 | 1.00 |
| ization | p- | (mol/mol) | 1.060 | 1.060 | 1.055 |
| | DCB/S | | | | |
| 2nd | NMP/S | (g/mol) | 10.1 | 3.8 | 3.0 |
| polymer- | NaOH/S | (mol/mol) | 1.06 | 1.06 | 1.07 |
| ization | p- | (mol/mol) | 1.060 | 1.060 | 1.055 |
| | DCB/S | | | | |

### Evaluation Example

The amount of CPMABA produced in the production of PAS, the nitrogen content in the PAS, and the weight average molecular weight of the PAS were measured as follows for each of Examples 1 and 2 and Comparative Examples 1 to 4.

<Measurement of CPMABA>

The slurry-like substance containing PAS after the completion of the polymerization reaction was cooled to room temperature, after which the slurry component was precisely weighed in a volumetric flask. The slurry-like substance when then mixed with a 40 mass % acetonitrile aqueous solution, and then agitated to extract CPMABA. The solution from which the CPMABA was extracted was filtered using a membrane filter. The obtained filtrate was used as a measurement sample and supplied to a high-speed liquid chromatograph (available from Hitachi High-Technologies Corporation, column oven “L-5025”, UV detector “L-4000”), and the content of CPMABA was measured. The synthesized CPMABA was used as the standard substance.

Furthermore, the produced amount of CPMABA per 1 mol of the sulfur source was calculated.

<Measurement of Nitrogen Content in PAS>

The nitrogen content in the PAS (unit: weight ppm) was determined by precisely weighing approximately 1 mg of PAS and subjecting the PAS to elemental analysis using a trace nitrogen and sulfur analyzer (model: ANTEK 7000, available from Astech Corporation).

<Weight Average Molecular Weight of PAS>

The weight average molecular weight (Mw) of the polymer was measured under the following conditions using the high-temperature gel permeation chromatograph (GPC) SSC-7101 available from Senshu Scientific, Co., Ltd. The weight average molecular weight was calculated after calibration with polystyrene standards.
Solvent: 1-chloronaphthalene,
Temperature: 210° C.
Detector: UV detector (360 nm)
Sample injection amount: 200 μL (concentration: 0.05 mass %)
Flow rate: 0.7 mL/min
Standard polystyrene: five types of standard polystyrene including 616000, 113000, 26000, 8200, and 600

The supply amount (A) (NMP/S) of NMP per mole of the sulfur source, the production amount (B) (CPMABA/S) of CPMABA produced per mole of the sulfur source, and the nitrogen content (C) (N amount/S) per mole of the sulfur source contained in the PAS are shown in Table 2 for Examples 1 and 2 and Comparative Examples 1 to 4.

TABLE 2

| | | | Com- | Com- | Com- | Com- |
|---|---|---|---|---|---|---|
| | | | parative | parative | parative | parative |
| | Exam- | Exam- | Exam- | Exam- | Exam- | Exam- |
| | ple | ple | ple | ple | ple | ple |
| | 1 | 2 | 1 | 2 | 3 | 4 |
| Polymerization | Con- | Con- | Con- | Batch | Batch | Batch |
| Form | tinuous | tinuous | tinuous | | | |
| (A) NMP/S | 3.0 | 2.5 | 6.1 | 10.1 | 3.8 | 3.0 |
| (mol/mol) | | | | | | |
| (B) CPMABA/S | 3.45 | 4.03 | 4.52 | 7.92 | 26.46 | 36.50 |
| (mmol/mol) | | | | | | |
| (C) | 5.17 | 5.35 | 5.63 | 1.95 | 5.94 | 7.25 |
| N amount/S | | | | | | |
| (mmol/mol) | | | | | | |
| (A) × (B)/(C) | 2.00 | 1.88 | 4.90 | 41.0 | 16.9 | 15.1 |
| (mol/mol) | | | | | | |

As shown in Table 2, when the production method of the examples was used, it was possible to maintain a high content of nitrogen in the PAS while suppressing the amount of the organic by-product CPMABA generated.

On the other hand, with the production method of Comparative Example 1, the high content of nitrogen in the PAS was maintained, but the amount of the generated CPMABA increased compared to the amount that was produced with the production method of the examples. Furthermore, the amount of CPMABA generated was not suppressed with the production method of Comparative Examples 2 to 4.

Moreover, the values of “(A)×(B)/(C)” in Table 2 show that as the value decreases, the characteristics of the PAS are improved while the amount of organic by-products is reduced. The results also show that productivity is high since the amount of the solvent is low. With the production method of the examples, the values of (A)×(B)/(C) were 4 mol/mol or less, and were all lower than the values of the comparative examples. From these results, it was found that in a comparison with the production method of the comparative examples, a reduction in the amount of organic by-products and an improvement in PAS characteristics can be compatibly achieved while increasing productivity.

1. A method of producing a polyarylene sulfide, the method comprising:
a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring a reaction mixture obtained through the polymerizing step among the reaction vessels; and
a recovering step of recovering the reaction mixture; wherein
a supply amount of the polar organic solvent is 5 mol or less per 1 mol of the sulfur source;
the reaction vessels are within a continuous production apparatus provided with a housing chamber accommodating the plurality of reaction vessels connected in series;
the reaction vessels are communicated with each other through a gas phase in the housing chamber;
the supply step, the water removal step, the polymerizing step, and the recovering step are performed in parallel; and
the polar organic solvent has a bond represented by —RO—N—, where R is C or P.

2. A method of producing a polyarylene sulfide, the method comprising:
a supply step of supplying a polar organic solvent, a sulfur source, and a dihalo aromatic compound as reaction raw materials to at least one of a plurality of reaction vessels communicating with each other through a gas phase;
a water removal step of removing at least a portion of water present in the reaction vessels;
a polymerizing step of performing a polymerization reaction in the plurality of reaction vessels;
a transfer step of sequentially transferring a reaction mixture obtained through the polymerizing step among the reaction vessels; and
a recovering step of recovering the reaction mixture; wherein
a supply amount of the polar organic solvent is 5 mol or less per 1 mol of the sulfur source;
the plurality of reaction vessels is connected through a ventilation unit so as to communicate with each other through the gas phase;
the reaction vessels adjacent to each other are connected by piping;
the supply step, the water removal step, the polymerizing step, and the recovering step are performed in parallel; and
the polar organic solvent has a bond represented by —RO—N—, where R is C or P.

3. The method of producing a polyarylene sulfide according to claim 1, wherein the plurality of reaction vessels is connected in order of a high maximum liquid surface level of liquid that can be accommodated in each reaction vessel; and
in the transfer step, the reaction mixture is sequentially transferred using a height difference in the maximum liquid surface level.

4. The method of producing a polyarylene sulfide according to claim 1, wherein the supply step, the water removal step, the polymerizing step, the transfer step, and the recovering step are performed in parallel.

5. The method of producing a polyarylene sulfide according to claim 1, wherein the polar organic solvent is a cyclic organic amide solvent; and
a value determined by Equation (1) is 4 mol/mol or less:
(A)×(B)/(C) (1),
where in Equation (1),
(A) represents a supply amount [mol/mol] of the cyclic organic amide solvent per 1 mol of the sulfur source;
(B) represents a produced amount [mmol/mol] of halogenated aromatic aminoalkyl acid per 1 mol of the sulfur source, the halogenated aromatic aminoalkyl acid being produced as an organic by-product in the polymerizing step; and
(C) represents a nitrogen content [mmol/mol] contained in the polyarylene sulfide per 1 mol of the sulfur source.

6. The method of producing a polyarylene sulfide according to claim 1, wherein the polar organic solvent is N-alkyl-2-pyrrolidone, and the dihalo aromatic compound is p-dichlorobenzene.

7. The method of producing a polyarylene sulfide according to claim 5, wherein the produced amount of the halogenated aromatic aminoalkyl acid is not greater than 4.3 mmol per 1 mol of the sulfur source.
